(19) United States
(12) Patent Application Publication
(10) Pub. No.: US 2025/0317881 A1
(43) Pub. Date: Oct. 9, 2025

(54) METHODS, ARCHITECTURES, APPARATUSES AND SYSTEMS FOR DUAL MOBILE TERMINATION

(71) Applicant: InterDigital Patent Holdings, Inc., Wilmington, DE (US)

(72) Inventors: Guanzhou Wang, Brossard (CA); Taimoor Abbas, Sainte-Julie (CA); Rocco Di Girolamo, Laval (CA); Anuj Sethi, Ottawa (CA); Michelle Perras, Montreal (CA); Xavier De Foy, Kirkland (CA)

(21) Appl. No.: 18/627,320

(22) Filed: Apr. 4, 2024

(51) Int. Cl. H04W 60/00; H04W 48/18; H04W 88/06

(52) U.S. Cl. CPC H04W 60/00; H04W 48/18; H04W 88/06

(57) ABSTRACT

Procedures, methods, architectures, apparatuses, systems, devices, and computer program products are provided for selecting mobile networks for two mobile terminations (MTs) in a device. For example, the first MT, having primary status, selects a mobile network and requests registration. It then activates the second MT, of secondary status, and provides it with information. The second MT selects one or more candidate mobile networks based on this information and provides data indicative of the candidate network to the first MT. The first MT provides additional information to the second MT, which then selects a mobile network based on this information and requests registration. The method also includes performing registration updates with the mobile networks, which can be triggered by a time period elapsing or an event occurring. Communications between the MTs may be performed using an inter-MT coordination function of the device.

### TECHNICAL FIELD

The present disclosure is generally directed to the fields of communications, hardware, software and encoding, including, for example, to methods, architectures, apparatuses and systems related to dual mobile termination (MT).

### BACKGROUND

According to some approaches, mechanisms for traffic steering, switching and splitting, e.g., between a Third Generation Partnership Project (3GPP) access network and a non-3GPP access network, are deficient in that certain access networks are incapable of providing sufficient service in certain conditions and times. For example, certain access networks may not provide sufficient service due to various factors such as network congestion, coverage limitations, or technical issues. The user experience is hindered and the efficiency of data transmission is limited.

### SUMMARY

A dual-MT device is provided. The dual-MT device may be configured for dual registration. The dual-MT device may be configured for Multi-Access Steering Switching and Splitting (MASSS) and/or Dual-Steer. The dual-MT device may be provided in a single UE or multiple UEs. The dual-MT device may be configured for PLMN selection. The dual-MT device may be configured for mobility and/or registration management.

Primary and secondary MTs may be coordinated for automatic PLMN selection. The Primary MT may control the activation/deactivation of the secondary MT based on a few criteria described. The primary MT may provide the information to the secondary MT to guide its PLMN and/or RAT search and selection.

The primary MT may perform a combined mobility registration update and/or a periodical registration update. The primary MT may provide the information of both primary and secondary MT to the PLMN. The primary MT may receive updated information for secondary MT during the combined registration update procedure. The primary MT may forward the updated information to the secondary MT.

In certain representative embodiments, a method performed by a device with first and second mobile terminations (MTs) is provided. For example, the first MT may be determined as primary. The first MT may select a mobile network. The first MT may request registration. The first MT may activate the second MT. The second MT may be determined as secondary. Primary and/or secondary MT determinations may be based on one or more criteria. The first MT may provide information to the second MT. The second MT may select one or more candidate mobile networks. The second MT may provide data about the candidate network to the first MT. The first MT may provide further information to the second MT. Based on the information, the second MT may select a mobile network. Based on the information, the second MT may request registration.

In certain representative embodiments, the method may include scenarios where the first and second mobile networks are the same, where they involve different public land mobile networks (PLMNs) and radio access technologies (RATs), and/or where the first mobile network is a home PLMN (HPLMN). For example, the method may include a registration update process. The registration update process may be based on elapsed time and/or event detection. An inter-MT coordination function may be provided for communication between the MTs.

In certain representative embodiments, a wireless transmit/receive unit (WTRU) comprising two MTs and terminal equipment (TE) is provided. For example, the WTRU may have the first and second MTs. The first and second MTs may be registered on a same mobile network. The first and second MTs may be registered on different mobile networks. One MT may be registered on one mobile network, and the other MT may be registered on another mobile network. The MTs may select one or more RATs on one or more PLMNs. The WTRU may receive configuration information from an HPLMN. The HPLMN may influence the activation criteria for the second MT. The first MT can perform a registration update with the first mobile network. The first MT may generate a message with information about both MTs. The first MT may provide the information about both MTs to the second MT. A decision to perform a registration update may be based on elapsed time (e.g., since a last update or a detection of an event). The MTs may have different update intervals. A shorter update interval of different update intervals may determine an update frequency. Communications between the MTs may be performed using an inter-MT coordination function.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit and/or receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a diagram illustrating an example of a UE;

FIG. 3 is a diagram illustrating an example of a dual-MT device;

FIG. 4 is a sequence diagram illustrating an example of inter-MT coordination for automatic PLMN selection;

FIG. 5 is a sequence diagram illustrating an example of a coordinated mobility registration update for a dual-MT device;

FIG. 6 is a procedural diagram illustrating an example procedure for selecting, from a respective plurality of available mobile networks, a respective mobile network for each of a first MT and a second MT;

FIG. 7 is a procedural diagram illustrating an example procedure for receiving configuration information from an HPLMN;

FIG. 8 is a procedural diagram illustrating an example procedure for mobile network communication involving a first MT deciding to update a registration with a network, generating and sending a message with information about first and second MTs, receiving a response from the network indicating acceptance of the update, and providing the information to the second MT; and

FIG. 9 is a procedural diagram illustrating another example procedure for selecting, from a respective plurality of available mobile networks, a respective mobile network for each of a first MT and a second MT.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

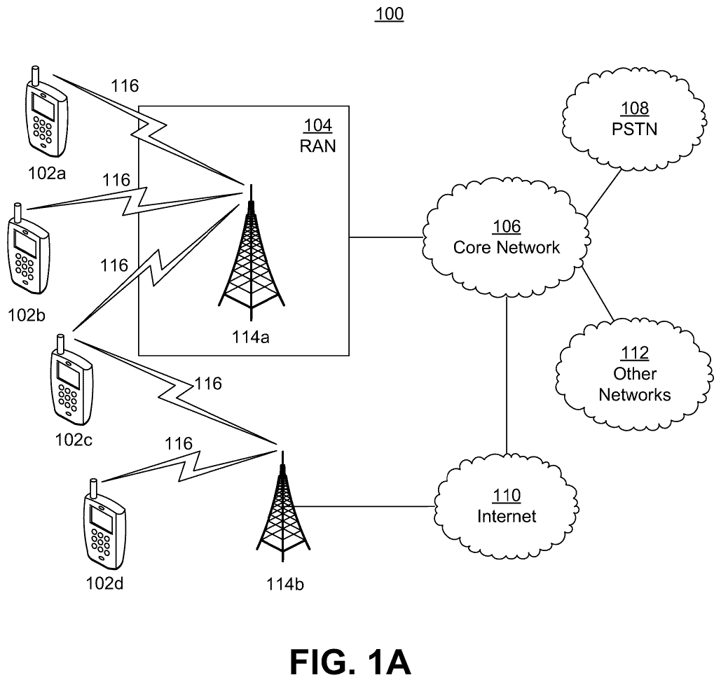

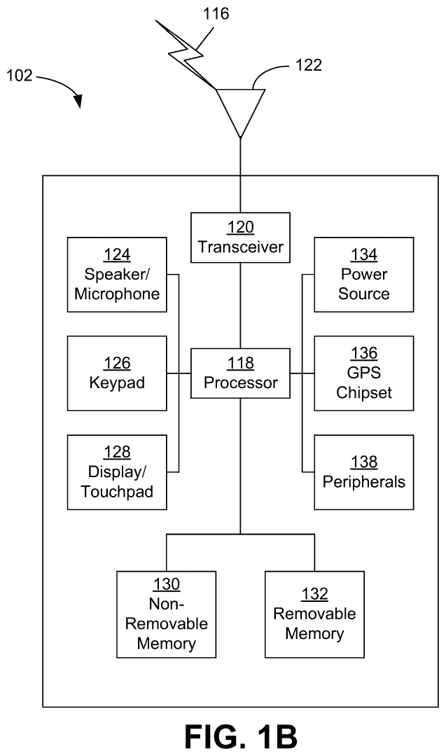

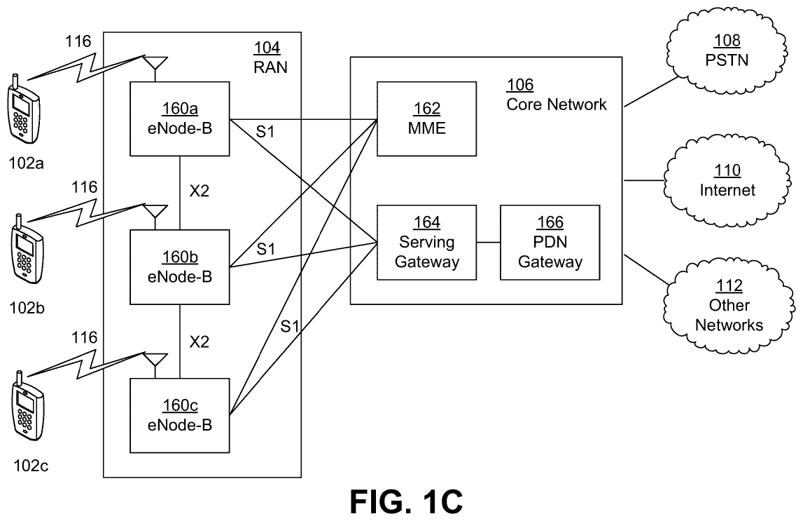

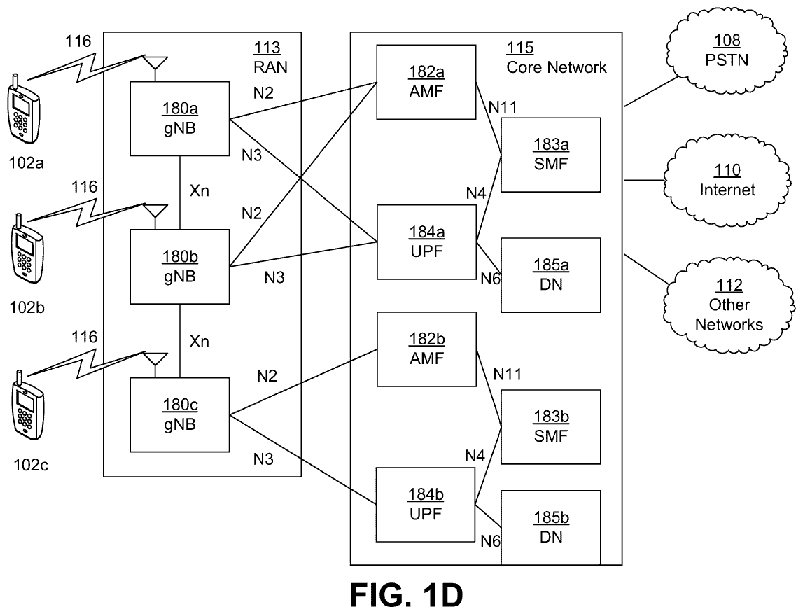

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit and/or receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable radio access technology (RAT) for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network. In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If, for example, the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast Fourier transform (IFFT) processing, and time domain processing, may be done on each stream separately. The streams may be mapped on to the two 80 MHz channels, and a transmitting STA may transmit the data. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if, for example, the AP, and other STAs in the BSS support 2 MHz, 4 MHZ, 8 MHz, 16 MHZ, and/or other channel bandwidth operating modes. Carrier sensing and/or network allocation vector (NAV) settings may depend on the status of the primary channel. If, for example, the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In certain representative embodiments, traffic steering and switching over two 3GPP access networks are provided. For example, support mechanisms for traffic steering are provided. Switching and splitting between a 3GPP access network (e.g., E-UTRA) or NR) and a non-3GPP access network (e.g., WiFi) are provided. Also, for example, Access Traffic Steering Switching and Splitting (ATSSS) is provided. Further, for example, mechanisms to support traffic steering and switching over two 3GPP access networks (e.g., MASSS and/or DualSteer) are provided.

In certain representative embodiments, various scenarios of one or more 3GPP access types (e.g., NR, Non-Terrestrial NR, E-UTRA) and one or more network types (e.g., Home Public Land Mobile Network (HPLMN), Visiting PLMN (VPLMN), Public Network Integrated-Non-Public Network (PNI-NPN)) are provided. For example, the 3GPP access networks are connected to various network types utilizing one or more 3GPP access types.

In certain representative embodiments, DualSteer is supported and enhanced. DualSteer functionalities are provided, including one or more of the following: (1) a “DualSteer device” should use two Subscription Permanent Identifiers (SUPIs) from the same operator for accessing two separate 3GPP access networks, e.g., each SUPI is used to connect to only one of the 3GPP access networks at any given time; (2) a “DualSteer device” may send its user data over two 3GPP access networks belonging to the same PLMN, either non-simultaneously or simultaneously; (3) a “DualSteer device” may send its user data over two 3GPP access networks belonging to two different PLMNs, either non-simultaneously or simultaneously; (4) in case of non-simultaneous data transmission over two networks, a “DualSteer device” can be a single UE, and in case of simultaneous data transmission, a “DualSteer device” can be “two separate UEs”; (5) in case of simultaneous data transmission, the data over two separate networks should belong to different services (or different Service Data Flows); and/or (5) at any given point of time, all traffic of a single service should be sent over a single access network, e.g., no service data splitting.

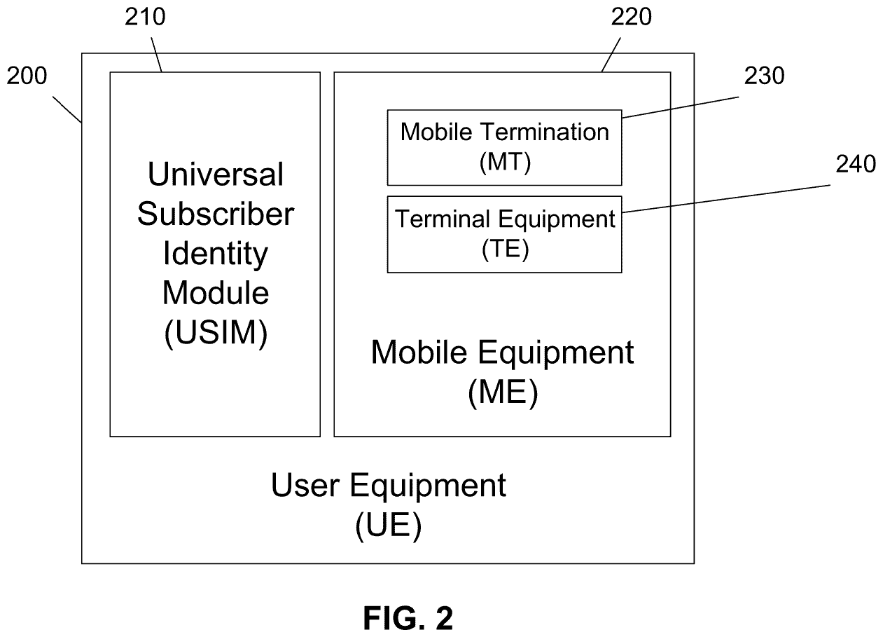

FIG. 2 illustrates a UE Functional Model. A UE is a device allowing a user access to network services. The interface between the UE and the network is the radio interface. The UE may be subdivided into a number of domains, the domains being separated by reference points. The domains may include the Universal Subscriber Identity Module (USIM) and Mobile Equipment (ME) domains. The ME Domain may be further subdivided into several components showing the connectivity between multiple functional groups, e.g., the Terminal Equipment (TE) and Mobile Termination (MT) domains.

In certain representative embodiments, inter-MT coordination for automatic PLMN selection is provided. For example, each MT in a dual-MT device may have a configuration for PLMN selection. The configuration for PLMN selection may be independent. The configuration may be stored in either MT or the USIM connected to the MT. For example, for a dual-MT device, a status (e.g., primary or secondary) of each MT may be determined following one or more rules. The primary and/or secondary MT may be coordinated for automatic PLMN selection. The primary MT may control the activation and/or deactivation of the secondary MT based on one or more criteria. The primary MT may provide information (e.g., primary-registered-PLMN and/or RAT and/or frequency) to the secondary MT. The information may guide a search for a PLMN and/or a RAT. The information may guide selection of a PLMN and/or a RAT. The primary MT may receive a list of available PLMN and/or RAT from the secondary MT. The primary MT may give guidance to the secondary MT for PLMN selection. The configuration (e.g., thresholds) and/or policy related to the Inter-MT coordination for PLMN selection may be provided by the HPLMN.

In certain representative embodiments, coordinated mobility and/or location update functions are provided. For example, the primary MT may perform a combined mobility registration update and/or a periodical registration update. The primary MT may provide the information of both primary and secondary MTs to the PLMN. The primary MT may receive updated information for the secondary MT during the combined registration update procedure. The primary MT may forward updated information to the secondary MT.

In certain representative embodiments, a dual-MT device is provided as two separate UEs. For example, each UE of a dual-MT device may function as a normal UE. Each UE of the dual-MT device may, in some embodiments, function without adapting hardware, stacks and/or behaviors. The dual-MT device may be configured to support DualSteer simultaneous data transmission.

In certain representative embodiments, a dual-MT device is provided that includes two separate MTs. For example, the dual MTs may be configured for inter-MT communication over one or more internal interfaces. Each MT may be configured in a manner that emulates a UE. For example, coordination of the two UEs and/or two MTs is provided. Enhancements and/or optimizations are provided to support one or more functionalities (e.g., for accessing a network and/or one or more services).

In certain representative embodiments, two UEs and/or MTs may be coordinated for cell and/or PLMN search and/or access. For example, two UEs and/or MTs may be optimized for mobility related procedures.

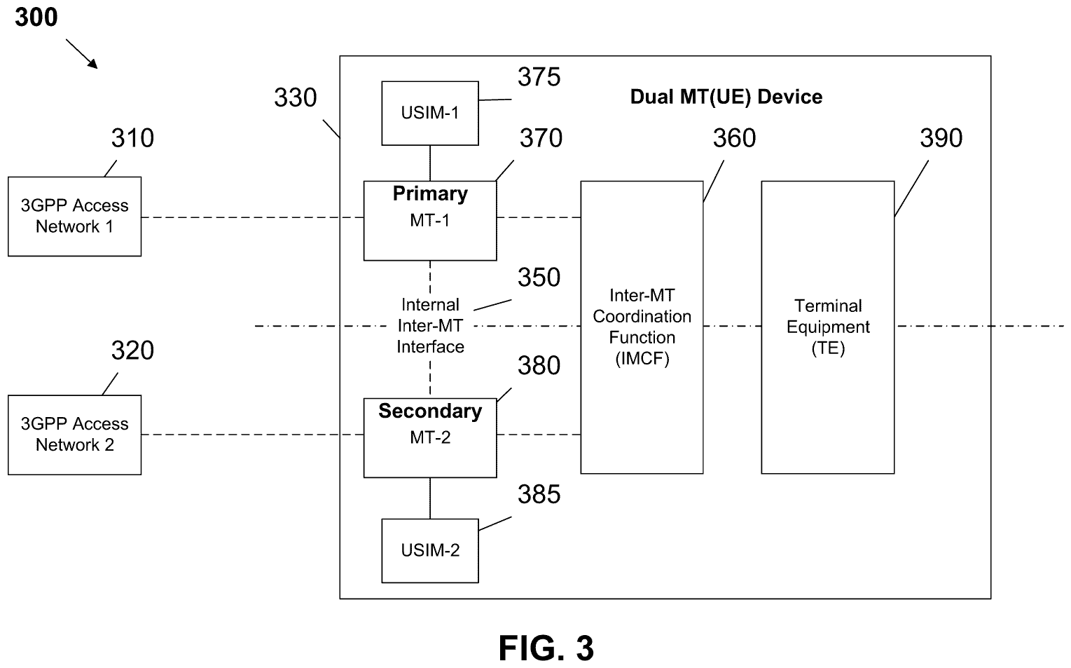

In certain representative embodiments, coordination between two MTs for cell and/or PLMN search and/or access is provided. For example, FIG. 3 is a diagram illustrating an example of a dual-MT device. In certain representative embodiments, a device may have two separate MTs and USIMs. For example, each MT may provide one or more functionalities that are in an MT of a UE (e.g., at least one of radio transmission, radio reception, baseband signal processing, access to USIM, access to CP stack, access to UP stack, combinations of the same, or the like). A common TE may be provided (as shown, for example, in FIG. 3). Two separate TEs corresponding to two MTs may be provided (not shown in FIG. 3). An internal inter-MT interface between two MTs may be provided. The internal inter-MT interface may be configured to allow two MTs to exchange information. For example, two MTs may exchange information through a higher layer (e.g., Layer 2 or Layer 3).

In certain representative embodiments, as illustrated in the example of FIG. 3, a system 300 is provided. The system 300 may include a dual-MT device 330 configured to communicate with a first 3GPP access network 310 and/or a second 3GPP access network 320. The dual-MT device 330 may include a first or primary MT 370 and a second or secondary MT 380. The first or primary MT 370 and the second or secondary MT 380 may communicate, e.g., via an internal inter-MT interface 350. The first or primary MT 370 may have a first USIM 375. The second or secondary MT 380 may have a second USIM 385.

For example, an Inter-MT Coordination Function (IMCF) 360 may be provided. The IMCF 360 may be provided in the higher layer. The IMCF 360 may be part of a TE 390. The communication between MTs or between the MT and the IMCF 360 may use AT commands. Two MTs may be identified by two unique device identifiers such as International Mobile Equipment Identities (IMEIs).

Two MTs in a dual-MT device may have same or different capabilities. For example, the two MTs in the dual-MT device may support different RAT and/or frequency bands. The two MTs in the dual-MT device may support different sets of features. The two MTs in the dual-MT device may have different configurations (e.g., network slicing configurations). The two MTs in the dual-MT device may have different policies (e.g., user equipment route selection policy (URSP) rules). The two MTs in the dual-MT device may have different features and/or configurations and/or policies. The different features and/or configurations and/or policies may be provided even when two MTs in the dual-MT device are used to connect to a same PLMN, for example.

The user of the device may have a dual-subscription with the same mobile network operator, e.g., having two UE identities (e.g., SUPIs) belonging to the dual-subscription. The user of the device may have two separate subscriptions with two different mobile network operators (MNOs), e.g., having two UE identities (e.g., SUPIs) belonging to two different subscriptions. Each MT in a dual-MT device may be associated with one UE identity (e.g., SUPI).

Two MTs in a dual-MT device may have different statuses. The different statuses may include one MT being the primary MT and the other being the secondary MT. The status of an MT may govern behavior and/or functionalities of the MT. For example, the primary MT may be activated first after device power-on. The primary MT may attempt to register to a network first. The primary MT may trigger the secondary MT to be activated and register to a network afterwards. The primary MT may receive policies from the network (e.g., HPLMN). The primary MT may use the policies to coordinate secondary MT behavior.

The status of an MT may be determined in various ways. For example, the physical USIM slots may be designated as primary or secondary. The MT connected to a primary USIM slot may become the primary MT. For another example, if, for example, the user has a dual-subscription with a same MNO and two SUPIs, one of the two SUPIs may be designated as the primary SUPI and the other as the secondary SUPI. The MT associated with the primary SUPI may become the primary MT. For another example, the MT that successfully registers to a network first becomes the primary MT. The user of the device may do the determination of the primary MT. The determination of the primary MT may be done based on the service selection by the user. For example, one MT may be preferred for a particular service over another (e.g., for voice over NR, one MT is determined as primary MT and the other MT is determined as secondary). The determination may be based on capabilities supported by the MT (e.g. 5G versus LTE, 5G USIM versus LTE USIM being inserted in the device). The IMCF may dynamically assign and/or update the roles of UEs as primary and secondary. The dynamic assignment and/or update may be based at least in part on one or more criteria, e.g., at least one of a coverage status, a service, combinations of the same, or the like.

An additional ID called a DualSteer-specific UE ID (DS-specific-UE-ID) may be used to interlink the primary and secondary MTs. The DualSteer-specific-UE-ID may be: (1) derived at the IMCF-layer (e.g., based on the application called application layer ID, based on the service called service-based ID, or the like); (2) configured by a policy control function (PCF) (e.g., when the DualSteer capability together with one or both SUPIs are provided at the initial registration by primary MT) (it is noted that such an ID may be called network-based coordination ID or linkage ID); (3) pre-configured in the UE; and/or (4) an ID associated with the primary MT (e.g., the SUPI associated with the primary MT). A hierarchy and/or a configuration order may vary. The hierarchy and/or the configuration order may be valid possible configuration options.

In certain representative embodiments, inter-MT coordination for automatic PLMN selection is provided. For example, each MT in a dual-MT device may have an independent configuration for PLMN selection. For example, the independent configuration may be stored in either MT or the USIM connected to the MT. The independent configuration may include a Registered PLMN, a User Controlled PLMN Selector with Access Technology, an Operator Controlled PLMN Selector with Access Technology, a list of Forbidden PLMNs, or the like.

The primary MT may start to select and register with a PLMN first, e.g., after the device power-on. After successfully registering with a PLMN (referred to as “primary-registered-PLMN” hereafter), the primary MT may report information to the IMCF. For example, the primary MT may report at least one of the primary-registered-PLMN identifier, the RAT the primary MT is using for accessing the primary-registered-PLMN, one or more UTRA Absolute Radio Frequency Channel Numbers (UARFCNs), one or more searched frequency bands, a current area identifier (e.g., a Cell Identifier, a Tracking Area Code, or the like) in the PLMN, combinations of the same, or the like, to the IMCF.

The secondary MT may be activated or deactivated. When deactivated, for example, the secondary MT may not perform any activity over the wireless link. In order to use the secondary MT, the secondary MT may need to be activated first.

The primary MT or the IMCF may govern activation or deactivation of the secondary MT. For examples, the primary MT or the IMCF may determine to activate the secondary MT under one or more of the following conditions: (1) the signal strength (e.g., Reference Signal Received Power (RSRP)) or quality (e.g., Reference Signal Received Quality (RSRQ)) of the primary-registered-PLMN has dropped below certain thresholds for a duration of time, and there is no other suitable cell for cell-reselection; (2) the Quality of Service (QOS) metrics (e.g., data loss rate, BER, or the like) of service data flows in the primary-registered-PLMN has dropped below certain thresholds; (3) the load of primary MT (e.g., central processing unit (CPU) utilization rate) has exceeded certain thresholds; (4) some service may benefit from DualSteer functionality (e.g., DualSteer functionality may be determined based on the UE policies); (5) NAS level rejections on the primary MT (e.g., congestion, N1 services disabled, DNN/S-NSSAI based congestions, or the like); (5) feature support on the primary MT (e.g., Circuit Switched Fallback (CSFB) not supported, Voice over IP (VOIP) and/or Voice over New Radio (VONR) not supported, or the like) may trigger for the activation or deactivation of the secondary MT; (6) primary MT has successfully camped on a desired cell (e.g., cell selection has been successful); and/or (7) like conditions.

For examples, the primary MT or the IMCF may determine to deactivate the secondary MT. The deactivation may be under one or more of the following conditions: (1) the battery level has dropped below a certain level; (2) there is no other radio access network type available (except the one that is used by the primary MT) for the secondary MT; (3) out of coverage for both primary and secondary MTs (e.g., the primary MT disables the secondary MT until the primary MT is able to get back to service, which may ensure both RFs are not engaged for radio scans); (4) there is no data transmission in secondary MT for a duration of time; (5) the load of the primary MT (e.g., CPU utilization rate) has dropped below certain thresholds; (6) there are no services benefiting from or using the DualSteer functionality; and/or (7) like conditions.

If, for example, the IMCF determines activating or deactivating the secondary MT, the IMCF may receive an event report from the primary MT. The event report may be triggered by one or more of the above-referenced exemplary conditions. Thresholds related to activation or deactivation decisions may be related to the above-referenced conditions and/or may be preconfigured in the MT, the IMCF or received from the network.

The secondary MT, after being activated, may start searching for the PLMN on its own (e.g., without the primary MT), based on independent configurations of the secondary MT. However, the secondary MT may receive the primary MT's registered PLMN information (e.g., the at least one of the primary-registered-PLMN identifier, the RAT the primary MT is using for accessing the primary-registered-PLMN, the one or more UARFCNs, the one or more searched frequency bands, the current area identifier in the PLMN, combinations of the same, or the like) from the primary MT or the IMCF. The information may be processed according to at least one of the following procedures: (1) the secondary MT may prioritize selecting the same or equivalent PLMN as the primary MT (e.g., considering primary-registered-PLMN as higher priority PLMN), but on a different RAT (e.g., having two MTs registered on the same PLMN but with different RATs may bring the benefits of coordinated mobility management, traffic steering and/or switching within the same PLMN, or the like); (2) the secondary MT may use the searched band information as well as provided potential ARFCNs from the primary MT to look for the desired PLMNs (e.g., this step may ensure that the secondary MT does not have to scan the radio to gather this information about the potential availability of the desired PLMNs); (3) the secondary MT may attempt to avoid searching for primary-registered-PLMN on the same RAT that the primary MT has used (e.g., if it supports other RAT types, the secondary MT may search for primary-registered-PLMN on those RAT types); and/or (4) the secondary MT may avoid using the same frequency bands as that has been used by the primary MT to avoid potential interference with each other.

The secondary MT may independently select a PLMN according to one or more of the above principles without the primary MT or IMCF approval. Alternatively, the secondary MT may report a list of available PLMN and/or RAT combinations to the primary MT. The secondary MT may wait for the primary MT or IMCF's instructions on PLMN selection. The priority of each PLMN and/or RAT in the list may be based on the secondary MT. The USIM's local configuration and the PLMN and/or RAT that has already been used by the primary MT may be removed from the list. The secondary MT may send the report periodically (e.g., based on a configured timer). The secondary MT may send the report when, e.g., there is change of the list. The secondary MT may send the report upon the (e.g., explicit) request of the primary MT or IMCF. The secondary MT may also send information (e.g., network signal strength, quality information, or the like) along with each PLMN and/or RAT in the list, e.g., to the primary MT or IMCF.

The primary MT or the IMCF may determine when, e.g., the secondary MT should start selecting and/or registering to a PLMN. The conditions for making such a decision may be similar to those for activating the secondary MT, as described herein. If, for example, the primary MT or the IMCF has received a list of available PLMNs and/or RATs from the secondary MT, the primary MT or the IMCF may choose one of the PLMNs and/or RATs from the list (e.g., not necessarily the highest priority in the list). The primary MT or the IMCF may instruct the secondary MT to select the PLMN. The primary MT or the IMCF may instruct the secondary MT to start registering to the target PLMN. The choice of the PLMN for the secondary MT may be based on service agreements between the PLMN operators and/or the HPLMN provided policies.

After successful registration to a PLMN, the secondary MT may report information (e.g., the secondary-registered-PLMN and/or the RAT/frequency band) to the primary MT or IMCF. The secondary MT may report to the primary MT or IMCF in case of a condition (e.g., PLMN selection, registration failure, or the like).

The primary MT or IMCF may indicate to the secondary MT to select and register to a different PLMN and start registering to this PLMN. For example, the selection and registration of the different PLMN may be based at least in part on a start of a new service requiring, e.g., DualSteer.

If, for example, the secondary MT is to be moved to a new PLMN and/or RAT, e.g., for connectivity reasons, the secondary MT may notify the primary MT or IMCF about the new PLMN and/or RAT. Alternatively, the secondary MT may send an indication to the primary MT or IMCF that the current PLMN and/or RAT fails a condition, e.g., is inappropriate. In response, the primary MT may choose another PLMN and/or RAT from the list of available PLMN and/or RAT from the secondary MT.

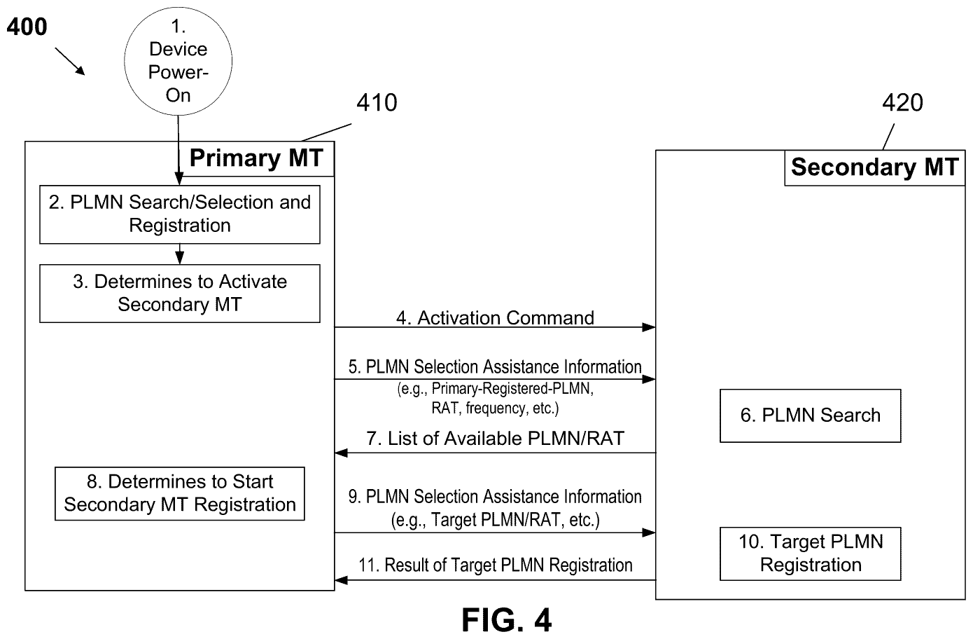

The coordination between the primary MT and the secondary MT for PLMN selection described herein is demonstrated, for example, in FIG. 4. Note that the IMCF is not shown in FIG. 4.

FIG. 4 is a sequence diagram illustrating an example of inter-MT coordination for automatic PLMN selection. In certain representative embodiments, a process 400 is provided. The process 400 may include communications between a primary MT 410 and a secondary MT 420. The process 400 may include a Device Power-On of the primary MT 410 (Step 1). The process 400 may include a function, e.g., a PLMN function (e.g., search, selection, and/or registration), at the primary MT 410 (Step 2). The process 400 may include determining, by the primary MT 410, to activate the secondary MT 420 (Step 3). The process 400 may include transmitting, e.g., from the primary MT 410, an activation command to the secondary MT 420 (Step 4). The process 400 may include transmitting, e.g., from the primary MT 410, PLMN information (e.g., PLMN selection assistance information including (e.g., primary-registered-PLMN identifier, the RAT the primary MT is using for accessing the primary-registered-PLMN, one or more UARFCNs, one or more searched frequency bands, a current area identifier in the PLMN, combinations of the same, or the like)) to the secondary MT 420 (Step 5). The process 400 may include a PLMN search at the secondary MT 420 (Step 6). The process 400 may include transmitting, e.g., from the secondary MT 420, a list of available PLMNs and/or RATs to the primary MT 410. The process 400 may include determining, e.g., at the primary MT 410, to start registration of the secondary MT 420 (Step 8). The process 400 may include transmitting, e.g., from the primary MT 410, additional PLMN information (e.g., target PLMN and/or RAT, or the like) to the secondary MT 420 (Step 9). The process 400 may include a registration of the target PLMN at the secondary MT 420 (Step 10). The process 400 may include transmitting, e.g., from the secondary MT 420, a result of the registration of the target PLMN to the primary MT 410 (Step 11).

The DualSteer-specific-UE-ID may be provided directly from the IMCF-layer. The DualSteer-specific-UE-ID may be passed from the primary MT to the secondary MT, for example, at Step 4 in the activation command. The DualSteer-specific-UE-ID may be passed from the primary MT to the secondary MT together with a SUPI of the primary MT.

In certain representative embodiments, configuration and policies related to inter-MT coordination for PLMN selection are provided. For example, for a dual-MT device that has Dual-subscription in the HPLMN, the HPLMN may have a configuration, which defines, e.g., the conditions and related thresholds that allow the device to determine when, e.g., to start activating the secondary MT and registering on a second PLMN or on the same PLMN on a different RAT. The configuration may be referred to as “operator controlled conditions for selecting a second PLMN or RAT.”

For example, the configuration may indicate that, e.g., after the primary MT has registered on a PLMN, the primary MT may activate the secondary MT and/or the secondary MT may start registering on a PLMN. The primary MT may activate the secondary MT and/or the secondary MT may start registering on the PLMN when, e.g., a signaling strength and/or quality of the primary-registered-PLMN drops below certain thresholds. For each RAT that the Second MT supports, the threshold configuration may be different.

For example, the configuration may indicate that the secondary MT may register on another PLMN or same primary-registered-PLMN on another RAT only under a certain condition, e.g., when the signaling strength or quality of another PLMN or another RAT is above certain thresholds. For each RAT that the secondary MT supports, the threshold configuration may be different.

For a dual-MT device that has Dual-subscription in the HPLMN, the HPLMN may have a list, which may be referred to as an “operator controlled second PLMN selector with access technologies.” The list may contain multiple PLMN and/or RAT combinations, e.g., in a priority order, that the secondary MT may try to select and register. The list may also be per primary-registered-PLMN, e.g., for a different primary-registered-PLMN, a different list of second PLMN and/or RAT is configured. For example, the list of a second PLMN and/or RAT when, e.g., the primary-registered-PLMN is HPLMN may be different for the list of the second PLMN and/or RAT when, e.g., the primary-registered-PLMN is VPLMN. In that case, a multiple list of second PLMN and/or RAT may be configured.

The “operator controlled conditions for selecting a second PLMN or RAT” and/or the “operator controlled second PLMN selector with access technologies” may be provided to the device during or after the primary MT registration to the HPLMN or a VPLMN, e.g., as part of Steering of Roaming information using NAS signaling. The HPLMN may also receive the MNO information of the subscriptions used by both MTs and take the MNO information into consideration for making the configuration.

In certain representative embodiments, coordinated mobility and/or location update for dual-MT device are provided. For example, the fact that two MTs in a dual-MT device may be in a same location makes it possible to optimize mobility and/or location update procedures for both MTs. Optimization may be provided when, e.g., the two MTs are registered in the same PLMN, even though each MT operates like a standalone UE.

In one optimization, when the primary MT or the secondary MT initiates a mobility Registration Update procedure, the primary MT or the secondary MT may include information (e.g., location information) of the other MT. Both MTs may update their location with the registered PLMN in one procedure. For example, when two MTs are registered in the same PLMN over different RATs, the registration area configuration may be different for two MTs. When, e.g., the mobility registration procedure is triggered at one MT because the registration area for its RAT (e.g., NR) has changed, it does not necessarily mean the registration area for the other MT's RAT (e.g., E-UTRA) has also changed. However, even if, for example, the other MT does not need to perform a mobility Registration Update, the optimization configures the PLMN to obtain the latest location information for both MTs without signaling cost. For this purpose, when, e.g., the mobility Registration Update procedure is triggered at one MT (“registering MT”), it may query the other MT, e.g., via the internal inter-MT interface or the IMCF. The query of the other MT may be a query one or more types of information. The information may include the temporary identifier (e.g., globally unique temporary identifier (GUTI) or 5G-GUTI) of the other MT. The temporary identifier may be assigned by the PLMN for the specific RAT (e.g., NR or E-UTRA) that the other MT is using. The GUTI or 5G-GUTI may contain the identifier (e.g., globally unique MME identifier (GUMMEI) or globally unique AMF identifier (GUAMI)) of the network entity (e.g., MME or AMF) that may control the registration. The information may include the identifier of the cell that the other MT is camping on. The information may include other user location information. The information may include other information. For example, the other MT might inform the PLMN (e.g., updated PDU Session Status, or the like).

The registering MT may store and/or otherwise transmit the information, e.g., in a container. The information may be part of a message, e.g., a Registration Request message. The Registration Request message may be sent to the network. For example, in an example Registration procedure, some information of the other MT described above, such as Cell Identifier or Location Information, may be sent as, e.g., N2 parameters instead of content of the Registration Request message. The information of the other MT may be sent as part of the Registration Request message.

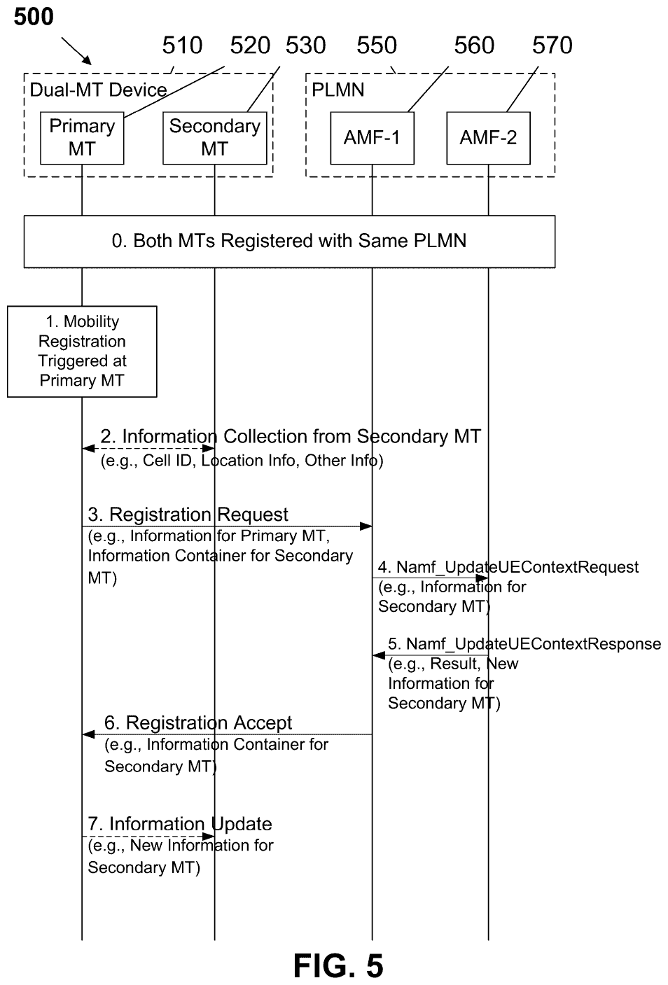

In certain representative embodiments, coordinated mobility registration update for dual-MT device is provided. For example, FIG. 5 is a sequence diagram illustrating an example of a coordinated mobility registration update for a dual-MT device. In certain representative embodiments, a process 500 is provided. The process 500 may include one or more communications between one or more of a dual-MT device 510, a primary MT 520 of the dual-MT device 510, a secondary MT 530 of the dual-MT device 510, a PLMN 550, a first AMF 560 of the PLMN 550, and a second AMF 570 of the PLMN 550. The process 500 may include one or more steps.

The process 500 may include Step 0. Step 0 may include registering the primary MT and the secondary MT with a same PLMN. The registering of the primary MT and the secondary MT with the same PLMN may utilize a different RAT. For example, the primary MT may access the network, e.g., via a gNB (not shown in FIG. 5) using, e.g., NR, and the secondary MT may access the network, e.g., via an NG-eNB (not shown in FIG. 5) using, e.g., E-UTRA. The primary MT and the secondary MT may be served by a same network function and/or entity. The primary MT and the secondary MT may be served by one or more different network functions and/or entities. In the example of FIG. 5, the primary MT 520 is served by the first AMF 560, and the secondary MT 530 is served by the second AMF 570.

The process 500 may include Step 1. Step 1 may include an update, e.g., a Mobility Registration Update. The Mobility Registration Update may be triggered at the primary MT 520. For example, the device has moved, e.g., to a new Tracking Area (TA) that is outside the primary MT's Registration Area. The PLMN may have different TA planning for different RATs, and the secondary MT's current TA and its Registration Area over a different RAT may be different from the MT's, even though they are in the same location. Therefore, when, e.g., the Mobility Registration is triggered at the primary MT 520, it may not necessarily be triggered at the secondary MT 530 at the same time.

The process 500 may include Step 2. Step 2 may be performed before the primary MT 520 initiates a procedure, e.g., a Registration procedure. The primary MT 520 may collect information from the secondary MT 530. The information may be collected for the purpose of updating the network with the secondary MT's latest information without extra signaling cost. The information may include one or more types of information. The information may include one or more of the following: (1) the temporary identifier (e.g., GUTI or 5G-GUTI) of the secondary MT 530; (2) the identifier of the cell that the secondary MT 530 is currently camping on; (3) other user location information; and/or (4) other information that the other MT might take the opportunity to inform the PLMN, e.g., updated PDU Session Status, or the like. In some embodiments, Step 2 may be optional, conditional, and/or omitted.

The information may be collected, e.g., via the internal Inter-MT interface or the IMCF. Step 2 may also be performed, e.g., periodically, without ongoing mobility registration triggering.

The process 500 may include Step 3. Step 3 may include the primary MT 520 sending a message, e.g., a Registration Request message to the PLMN (e.g., the first AMF 560) to initiate the Registration procedure. In addition to information needed for a registration update for the primary MT 520, the message may include an “Information Container” for the secondary MT 530. The “Information Container” may contain the identifier of the secondary MT (e.g., GUTI) and other information described in Step 2.

The process 500 may include Step 4. Step 4 may include a conditional operation. For example, if the secondary MT 530 is served by another AMF, the first AMF 560 may locate the second AMF 570 serving the secondary MT 530, e.g., via the identifier (e.g., GUTI) of the secondary MT 530 and forward the information of the secondary MT 530 to the second AMF 570, e.g., by invoking an AMF service request (e.g., an Namf_UpdateUEContext request). The second AMF 570 may update a context, e.g., a UE context, of the second AMF 570 using the information received. The second AMF 570 may perform some actions accordingly (e.g. restart the inactivity timer). The second AMF 570 may forward some information to other NFs (e.g., unified data management (UDM) or a new AMF if, for example, the secondary MT's new location should be served by another AMF).

The process 500 may include Step 5. Step 5 may include the second AMF 570 returning a response, e.g., an Namf_UpdateUEContext response, to the first AMF 560. The second AMF 570 may send a result, such as “Accept” or “Not handled”, to the first AMF 560. The second AMF 570 may also provide some new information (e.g., new Registration Area) that may require updating at the device side.

The process 500 may include Step 6. Step 6 may include, after the primary MT's Registration procedure is completed, the first AMF 560 returns a message, e.g., the Registration Accept message, to the primary MT 520. The first AMF 560 may output the Result and new information received for the secondary MT 530, e.g., in an information container included in the Registration Accept message.

The process 500 may include Step 7. Step 7 may include the primary MT 520 forwarding the received result and/or new information to the secondary MT 530. The secondary MT 530 may update a configuration and/or context (e.g., new Registration Area) of the secondary MT 530 with the new information received. Based on the received result, the secondary MT 530 may take one or more further actions. For example, if the result indicates that the information provided by the secondary MT 530 is, e.g., “not handled” by the network, the secondary MT 530 may initiate a procedure, e.g., a Registration update procedure, for the secondary MT 530. In some embodiments, Step 7 may be optional, conditional, and/or omitted.

In another optimization, the primary MT and the secondary MT may synchronize their periodical Registration update procedure, e.g., performing one combined periodical Registration procedure for both MTs at the same time. The combined periodical Registration may be performed by either of the two MTs and the other MT may stop the activity (e.g., timer management) for periodical Registration. The shortest time interval may be used for the combined periodic registration update. For example, if a primary MT has a shorter periodic interval configured while a secondary MT has a longer interval, then a shorter interval from the primary MT may be used to periodically update the registration of both MTs. Similarly, as the first optimization, the registering MT may obtain the information from the other MT for update in the PLMN.

When the PLMN receives a combined periodical Registration request, it may recognize that it does not need to continue to monitor the periodical registration for the other MT. For example, it may stop (or restart) the relevant timer for the other MT.

In certain representative embodiments, a method is performed by a device. For example, the device may comprise a first mobile termination (MT) and a second MT. The device may, for example, be configured for selecting, e.g., from a respective plurality of available mobile networks, a respective mobile network for each of the first MT and the second MT. The device may be one device or plural devices.

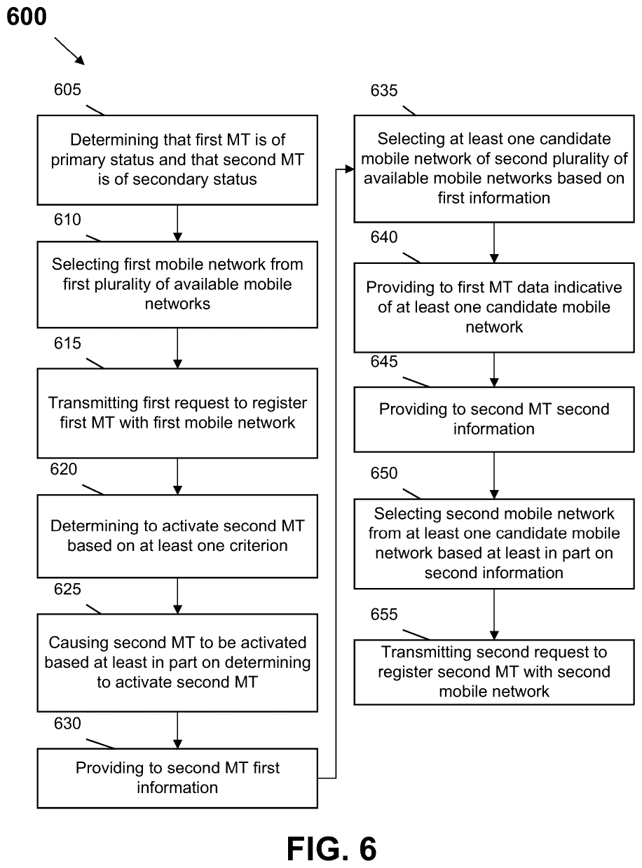

For example, FIG. 6 is a procedural diagram illustrating an example procedure 600 for selecting, e.g., from a respective plurality of available mobile networks, a respective mobile network for each of a first MT and a second MT. The procedure 600 may include determining 605, e.g., by the first MT, that the first MT is of a primary status and that the second MT is of a secondary status. The procedure 600 may include based at least in part on determining that the first MT is of the primary status, selecting 610, e.g., by the first MT, a first mobile network from a first plurality of available mobile networks. The procedure 600 may include transmitting 615, e.g., by a device (e.g., a WTRU or component thereof), a first request to register the first MT with the first mobile network. The procedure 600 may include determining 620, e.g., by the first MT, to activate the second MT based on at least one criterion. The procedure 600 may include causing 625, e.g., by the first MT, the second MT to be activated based at least in part on determining to activate the second MT. The procedure 600 may include providing 630, e.g., by the first MT, to the second MT first information. The procedure 600 may include selecting 635, e.g., by the second MT, at least one candidate mobile network of a second plurality of available mobile networks based on the first information. The procedure 600 may include providing 640, e.g., by the second MT, to the first MT data indicative of the at least one candidate mobile network. The procedure 600 may include providing 645, e.g., by the first MT, to the second MT second information. The procedure 600 may include selecting 650, e.g., by the second MT, a second mobile network from the at least one candidate mobile network based at least in part on the second information. The procedure 600 may include transmitting 655 a second request to register the second MT with the second mobile network.

In some implementations, the first mobile network and the second mobile network may be in common. For example, the first mobile network may comprise a first public land mobile network (PLMN) and the second mobile network may comprise a second PLMN. The first mobile network and the second mobile network may be different.

In some implementations, different network technologies may be selected on various networks based on specific data. For example, the first MT may select a first radio access technology (RAT) on the first PLMN. The second MT may select a second RAT on the second PLMN based at least in part on the second information. RAT selection may occur before PLMN selection.

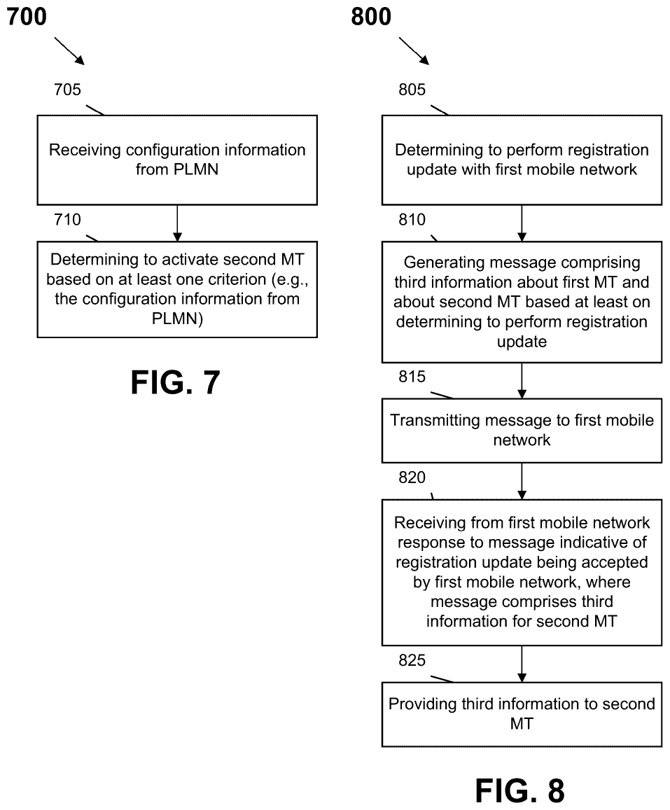

In some implementations, the first mobile network may comprise a home public land mobile network (HPLMN). FIG. 7 is a procedural diagram illustrating an example procedure 700 for receiving 705 configuration information from the HPLMN. The procedure 700 may include determining 710, e.g., by the first MT, to activate the second MT based on at least one criterion. For example, the at least one criterion may be based at least in part on the configuration information.

FIG. 8 is a procedural diagram illustrating an example procedure 800 for mobile network communication. The procedure 800 may involve one or more of the following: a first MT deciding to update a registration with a network, generating and sending a message with information about first and second MTs, receiving a response from the network indicating acceptance of the update, and providing the information to the second MT. For example, the procedure 800 may include determining 805, e.g., by the first MT, to perform a registration update with the first mobile network. The procedure 800 may include generating 810, e.g., by the first MT, a message comprising third information about the first MT and about the second MT based at least on determining to perform the registration update. The procedure 800 may include transmitting 815 the message to the first mobile network. The procedure 800 may include receiving 820, e.g., by the first MT, from the first mobile network a response to the message indicative of the registration update being accepted by the first mobile network, wherein the message comprises third information for the second MT. The procedure 800 may include providing 825, e.g., by the first MT, the third information to the second MT.

In some implementations, the determining 805 to perform the registration update may be based at least in part on a time period elapsing since a previous registration update was performed. For example, the first MT may be configured to update its registration with the first mobile network at a first periodic interval, and the second MT may be configured to update its registration with the second mobile network at a second periodic interval. For example, the time period may be a lesser of the first periodic interval and the second periodic interval.

In some implementations, the determining 805 to perform the registration update may be based at least in part on a detection of an event occurring.

In some implementations, communications between the first MT and the second MT may be performed using an inter-MT coordination function 360 of the device.

In certain representative embodiments, a wireless transmit/receive unit (WTRU) 330 is provided. For example, the WTRU 330 may include a first mobile termination (MT) 370, a second MT 380, and terminal equipment (TE) 390. The first MT 370 may determine 605 that the first MT 370 is of a primary status and that the second MT 380 is of a secondary status. The first MT may select 610 a first mobile network 310 (e.g., a first 3GPP access network) from a first plurality of available mobile networks. The selecting 610 may be based at least in part on determining that the first MT 370 is of the primary status. The TE 390 may transmit 615 a first request to register the first MT 370 with the first mobile network 310. The first MT 370 may determine 620 to activate the second MT 380. The determining 620 may be based on at least one criterion. The first MT 370 may cause 625 the second MT 380 to be activated. The causing 625 may be based at least in part on determining to activate the second MT 380. The first MT 370 may provide 630 to the second MT 380 first information. The second MT 380 may select 635 at least one candidate mobile network of a second plurality of available mobile networks. The selecting 636 may be based at least in part on the first information. The second MT 380 may provide 640 to the first MT 370 data. The data may be indicative of the at least one candidate mobile network. The first MT 370 may provide 645 to the second MT 380 second information. The second MT 380 may select 650 a second mobile network 320 (e.g., a second 3GPP access network) from the at least one candidate mobile network. The selecting 650 may be based at least in part on the second information. The TE 390 may transmit 655 a second request to register the second MT 380 with the second mobile network 320.

In some implementations, the first mobile network 310 and the second mobile network 320 may be in common. For example, the first mobile network 310 may comprise a first public land mobile network (PLMN), and the second mobile network 320 may comprise a second PLMN. The first mobile network and the second mobile network may be different.

For example, the first MT 370 may select 705 a first radio access technology (RAT) on the first PLMN. The second MT 380 may select 710 a second RAT on the second PLMN. The selecting 710 may be based at least in part on the second information.

For example, the first mobile network 310 may comprise a home public land mobile network (HPLMN). The WTRU 330 may receive 705 configuration information from the HPLMN. The first MT 370 may determine 710 to activate the second MT 380. The determining 710 may be based at least in part on at least one criterion. For example, the at least one criterion may be based at least in part on the configuration information.

In some implementations, the first MT 370 may determine 805 to perform a registration update with the first mobile network 310. The first MT 370 may generate 810 a message comprising third information about the first MT 370 and about the second MT 380. The generating 810 may be based at least in part on determining to perform the registration update. The first MT 370 may transmit 815 the message to the first mobile network 310. The first MT 370 may receive 820 from the first mobile network 310 a response to the message indicative of the registration update being accepted by the first mobile network 310. The message may comprise third information for the second MT 380. The first MT 370 may provide 825 the third information to the second MT 380.

For example, the first MT 370 may determine 805 to perform the registration update. The determining 805 may be based at least in part on a time period elapsing since a previous registration update was performed. The first MT 370 may be configured to update its registration with the first mobile network 310 at a first periodic interval. The second MT 380 may be configured to update its registration with the second mobile network 320 at a second periodic interval. The time period may be a lesser of the first periodic interval and the second periodic interval. The first MT 370 may determine to perform the registration update based at least in part on a detection of an event occurring.

For example, communications between the first MT 370 and the second MT 380 may be performed using an inter-MT coordination function 360 of the device.

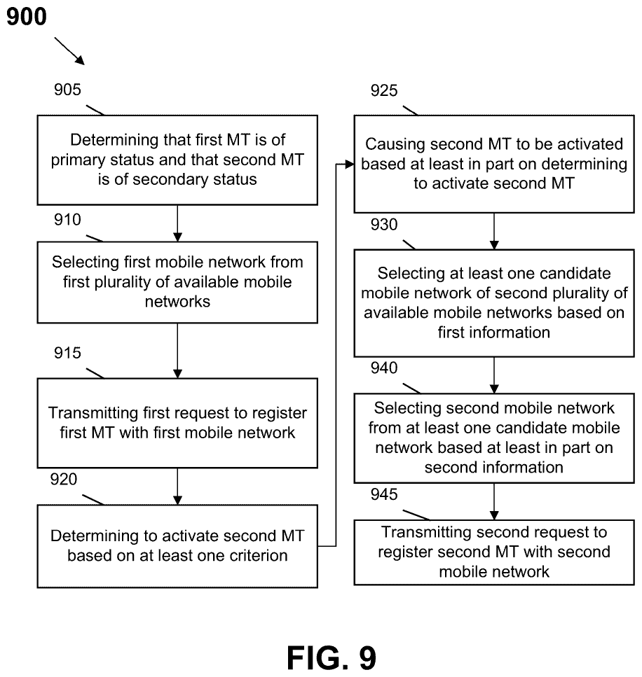

For example, FIG. 9 is a procedural diagram illustrating an example procedure 900 for selecting, e.g., from a respective plurality of available mobile networks, a respective mobile network for each of a first MT and a second MT. The procedure 900 may include determining 905, e.g., by the first MT, that the first MT is of a primary status and that the second MT is of a secondary status. The procedure 900 may include selecting 910, e.g., by the first MT, a first mobile network from a first plurality of available mobile networks. The selection 910 may be based at least in part on determining that the first MT is of the primary status. The procedure 900 may include transmitting 915, e.g., by a device (e.g., a WTRU or component thereof), a first request to register the first MT with the first mobile network. The procedure 900 may include determining 920, e.g., by the first MT, to activate the second MT based on at least one criterion. The procedure 900 may include causing 925, e.g., by the first MT, the second MT to be activated based at least in part on determining to activate the second MT. The procedure 900 may include selecting 930, e.g., by the second MT, at least one candidate mobile network of a second plurality of available mobile networks based on the first information. The procedure 900 may include selecting 940, e.g., by the second MT, a second mobile network from the at least one candidate mobile network based at least in part on the second information. The procedure 900 may include transmitting 945 a second request to register the second MT with the second mobile network.

Each of the contents of the following references is incorporated by reference herein in their entireties: (1) 3GPP SP-231802, New SID on Multi-Access (DualSteer and ATSSS_Ph4); (2) 3GPP TR 23.700-54, Study on Multi-Access (DualSteer and ATSSS_Ph4) (Release 19), V0.2.0; (3) 3GPP TS 22.261, Service requirements for the 5G system; Stage 1 (Release 19), V19.5.0; (4) 3GPP TS 23.501, System architecture for the 5G System (5GS); Stage 2 (Release 18), V18.4.0; (5) 3GPP TS 23.101, General Universal Mobile Telecommunications System (UMTS) architecture (Release 17); (6) 3GPP TS 23.122, Non-Access-Stratum (NAS) functions related to Mobile Station (MS) in idle mode (Release 18), V18.5.0; (7) 3GPP TS 38.304, User Equipment (UE) procedures in Idle mode and RRC Inactive Mode (Release 18), V18.0.0; (8) 3GPP S2-2402960, DualSteer Solution for Kis 1.1, 1.2, 1.x (policies), 1.y (session establishment): DualSteer Protocol Stack model; and (9) 3GPP TS 38.413, NG Application Protocol (NGAP) (Release 18), V18.0.0.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only and should not be taken as limiting the scope of the following claims. For instance, the embodiments provided herein include handheld devices, which may include or be utilized with any appropriate voltage source, such as a battery or the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type of medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, 6, 35 U.S.C. § 112 (f) or means-plus-function claim format, and any claim without the terms “means for” is not so intended.

What is claimed:

1. A method performed by a wireless transmit/receive unit (WTRU) comprising a first mobile termination (MT) and a second MT for selecting, from a respective plurality of available mobile networks, a respective mobile network for each of the first MT and the second MT, the method comprising:
determining, by the first MT, that the first MT is of a primary status and that the second MT is of a secondary status;
based at least in part on determining that the first MT is of the primary status, selecting by the first MT, a first mobile network from a first plurality of available mobile networks;
transmitting, by the device, a first request to register the first MT with the first mobile network;
determining, by the first MT, to activate the second MT based on at least one criterion;
causing, by the first MT, the second MT to be activated based at least in part on determining to activate the second MT;
providing, by the first MT, to the second MT first information;
selecting, by the second MT, at least one candidate mobile network of a second plurality of available mobile networks based on the first information;
providing, by the second MT, to the first MT data indicative of the at least one candidate mobile network;
providing, by the first MT, to the second MT second information;
selecting, by the second MT, a second mobile network from the at least one candidate mobile network based at least in part on the second information; and
transmitting a second request to register the second MT with the second mobile network.

2. The method of claim 1, wherein the first mobile network and the second mobile network are in common.

3. The method of claim 1, wherein the first mobile network and the second mobile network are different.

4. The method of claim 1, wherein the first mobile network comprises a first public land mobile network (PLMN) and the second mobile network comprises a second PLMN, the method further comprising:
selecting a first radio access technology (RAT) on the first PLMN; and
selecting a second RAT on the second PLMN based at least in part on the second information.

5. The method of claim 1, wherein the first mobile network comprises a public land mobile network (PLMN), the method further comprising receiving configuration information from the PLMN, wherein the at least one criterion is based at least in part on the configuration information.

6. The method of claim 1, further comprising:
determining to perform a registration update with the first mobile network;
generating a message comprising third information about the first MT and about the second MT based at least on determining to perform the registration update;
transmitting the message to the first mobile network;
receiving from the first mobile network a response to the message indicative of the registration update being accepted by the first mobile network, wherein the message comprises fourth information for the second MT.

7. The method of claim 6, wherein determining to perform the registration update is based at least in part on a time period elapsing since a previous registration update was performed.

8. The method of claim 7, wherein:
the first MT is configured to update its registration with the first mobile network at a first periodic interval and the second MT is configured to update its registration with the second mobile network at a second periodic interval, and
the time period is a lesser of the first periodic interval and the second periodic interval.

9. The method of claim 1, wherein communications between the first MT and the second MT are performed using an inter-MT coordination function of the WTRU.

10. The method of claim 1, wherein the first information and the second information comprise respective data indicative of the first MT's configuration.

11. A wireless transmit/receive unit (WTRU) comprising:
a first mobile termination (MT);
a second MT; and
terminal equipment (TE), wherein:
the first MT is to determine that the first MT is of a primary status and that the second MT is of a secondary status,
based at least in part on determining that the first MT is of the primary status, the first MT is to select a first mobile network from a first plurality of available mobile networks,
the TE is to transmit a first request to register the first MT with the first mobile network,
the first MT is to determine to activate the second MT based on at least one criterion,
the first MT is to cause the second MT to be activated based at least in part on determining to activate the second MT,
the first MT is to provide to the second MT first information,
the second MT is to select at least one candidate mobile network of a second plurality of available mobile networks based on the first information,
the second MT is to provide to the first MT data indicative of the at least one candidate mobile network,
the first MT is to provide to the second MT second information,
the second MT is to select a second mobile network from the at least one candidate mobile network based at least in part on the second information, and
the TE is to transmit a second request to register the second MT with the second mobile network.

12. The WTRU of claim 11, wherein the first mobile network and the second mobile network are in common.

13. The WTRU of claim 11, wherein the first mobile network and the second mobile network are different.

14. The WTRU of claim 11, wherein:
the first mobile network comprises a first public land mobile network (PLMN) and the second mobile network comprises a second PLMN,
the first MT selects a first radio access technology (RAT) on the first PLMN, and
the second MT selects a second RAT on the second PLMN based at least in part on the second information.

15. The WTRU of claim 11, wherein:
the first mobile network comprises a public land mobile network (PLMN),
the WTRU is to receive configuration information from the PLMN; and
the at least one criterion is based at least in part on the configuration information.

16. The WTRU of claim 11, wherein:
the first MT is to:
determine to perform a registration update with the first mobile network,
generate a message comprising third information about the first MT and about the second MT based at least on determining to perform the registration update,
transmit the message to the first mobile network, and
receive from the first mobile network a response to the message indicative of the registration update being accepted by the first mobile network; and
the message comprises fourth information for the second MT.

17. The WTRU of claim 16, wherein the first MT is to determine to perform the registration update based at least in part on a time period elapsing since a previous registration update was performed.

18. The WTRU of claim 17, wherein:
the first MT is configured to update its registration with the first mobile network at a first periodic interval and the second MT is configured to update its registration with the second mobile network at a second periodic interval, and
the time period is a lesser of the first periodic interval and the second periodic interval.

19. The WTRU of claim 11, wherein communications between the first MT and the second MT are performed using an inter-MT coordination function of the WTRU.

20. A method performed by a wireless transmit/receive unit (WTRU) comprising a first mobile termination (MT) and a second MT for selecting, from a respective plurality of available mobile networks, a respective mobile network for each of the first MT and the second MT, the method comprising:
determining that the first MT is of a primary status and that the second MT is of a secondary status;
based at least in part on determining that the first MT is of the primary status, selecting a first mobile network from a first plurality of available mobile networks;
transmitting a first request to register the first MT with the first mobile network;
determining to activate the second MT based on at least one criterion;
causing the second MT to be activated based at least in part on determining to activate the second MT;
selecting at least one candidate mobile network of a second plurality of available mobile networks based on first information;
selecting a second mobile network from the at least one candidate mobile network based at least in part on second information; and
transmitting a second request to register the second MT with the second mobile network.
